(19) United States
(12) Patent Application Publication
(10) Pub. No.: US 2015/0243079 A1
(43) Pub. Date: Aug. 27, 2015

(54) HEAD MOUNTED DISPLAY PROVIDING CLOSED-VIEW AND METHOD OF CONTROLLING THEREFOR

(71) Applicant: LG ELECTRONICS INC., Seoul (KR)

(72) Inventors: Eunhyung CHO, Seoul (KR); Doyoung LEE, Seoul (KR); Jongho KIM, Seoul (KR); Sinae CHUN, Seoul (KR)

(21) Appl. No.: 14/322,602

(22) Filed: Jul. 2, 2014

(30) Foreign Application Priority Data
Feb. 27, 2014 (KR) 10-2014-0023108

(51) Int. Cl. G06T 19/00; G02B 27/01

(52) U.S. Cl. CPC G06T 19/006; G02B 27/017; G02B 2027/0178

(57) ABSTRACT

According to one embodiment of the present specification, a method of controlling head mounted display (HMD) providing a closed-view includes the steps Of displaying a virtual reality image, detecting a first movement of a first real object positioned at the outside of the HMD, and selectively providing information on the first real object in a first part of the virtual reality image based on the first movement. In this case, the first part is configured in response to a position of the first real object and the first movement can be compensated by a second movement of the HMD in case of performing the step of detecting the first movement of the first real object.

Pursuant to 35 U.S.C. §119(a), this application claims the benefit of the Korean Patent Application No. 102014-0023108 filed on Feb. 27, 2014, which is hereby incorporated by reference as if fully set forth herein.

### BACKGROUND THE INVENTION

1. Field of the Invention

The present specification relates to a head mounted display, and more particularly, to a head mounted display providing a closed-view to a user wearing the head mounted display and a method of controlling therefor.

2. Discussion of the Related Art

A head mounted display can display a virtual reality image and provide the virtual reality to a user. The head mounted display can be classified into an open-view type capable of watching the virtual reality image together with information on a real object of real space and a closed-view type capable of watching the virtual reality image only.

The head mounted display of the closed-view type can provide a user with an increased sensation of immersion by providing the virtual reality image only. Yet, since the head mounted display of the closed-view type cannot provide the information on the real object of the real space to the user, the user cannot recognize an event occurred in the real space.

### SUMMARY OF THE INVENTION

Accordingly, the present specification is directed to an apparatus and method thereof that substantially obviate one or more problems due to limitations and disadvantages of the related art.

An object of the present specification is to provide a head mounted display of a closed-view type and a method of controlling therefor. In particular, the present specification intends to provide a device for providing information on a real object of real space to the head mounted display of the closed-view type and a method of controlling therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a head mounted display (MID) providing a closed-view includes a display unit configured to display a virtual reality image, a sensor unit configured to sense a real object positioned at the outside of the HMD, and a controller configured to control the display unit and the sensor unit, the controller configured to detect a first movement of a. first real object via the sensor unit, the controller configured to selectively provide information on the first real object in a first part of the virtual reality image based on the first movement, wherein the first part is configured in response to a position of the first real object, the controller configured to compensate for a second movement of the sensor unit, which has sensed the first real object, in case of detecting the first movement of the first real object.

According to one embodiment, a method of controlling a head mounted display (HMD) providing a closed-view includes the steps of displaying a virtual reality image, detecting a first movement of a first real object positioned at the outside of the HMD, and selectively providing information on the first real object in a first part of the virtual reality image based on the first movement, wherein the first part is configured in response to a position of the first real object and wherein the first movement is compensated by a second movement of the HMD in case of performing the step of detecting the first movement of the first real object.

According to the present specification, a head mounted display can provide a virtual reality image via a closed-view.

According to the present specification, a head mounted display can provide information on a real object of real space together with a virtual reality image.

According to the present specification, a head mounted display can detect a movement of a real object of real space.

According to the present specification, a head mounted display can provide an image of a real object of which a movement is detected to a user together with a virtual reality image.

According to the present specification, a head mounted display can provide an image of a real object together with a virtual reality image based on a distance from the real object.

According to the present specification, if a real object of no movement is close to a head mounted display less than a predetermined distance, the head mounted display can provide an image of the real object together with a virtual reality image.

It is to be understood that both the foregoing general description and the following detailed description of the present specification are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for a head mounted display according to one embodiment of the present specification;

FIG. 2 is a diagram for a shape of a virtual reality image provided by a HMD according to one embodiment of the present specification;

FIG. 3 is a diagram for a virtual image provided by a HMD according to one embodiment of the present specification;

FIG. 4 is a diagram of a method for a HMD according to one embodiment of the present specification to display information on a real object in accordance with a movement of the real object;

FIG. 5 is a diagram of a method for a HMD according to one embodiment of the present specification to selectively provide information on a real object of which a movement has occurred;

FIG. 6 is a diagram of a method for a HMD according to one embodiment of the present specification to provide information in accordance with a distance between a fixed real object and the HMD;

FIG. 7 is a diagram of a method for a HMD according to one embodiment of the present specification to display an indicator;

FIG. 8 is a diagram of a method for a HMD according to one embodiment of the present specification to display information of a real object using PIP (picture in picture);

FIG. 9 is a block diagram for a HMD according to one embodiment of the present specification;

FIG. 10 is an operation flowchart for a HMD according to one embodiment of the present specification.

### DETAILED DESCRIPTION OF THE INVENTION

While the embodiments have been explained in detail with reference to the attached diagrams and the contents written on the diagrams, a scope of claims may be non-restricted or non-limited to the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

In the following description, a head mounted display can display a movie image of a hemisphere form, a video image, a still image as well as a virtual reality image, Following description is explained with an example of a virtual reality image, by which the present specification may be non-limited.

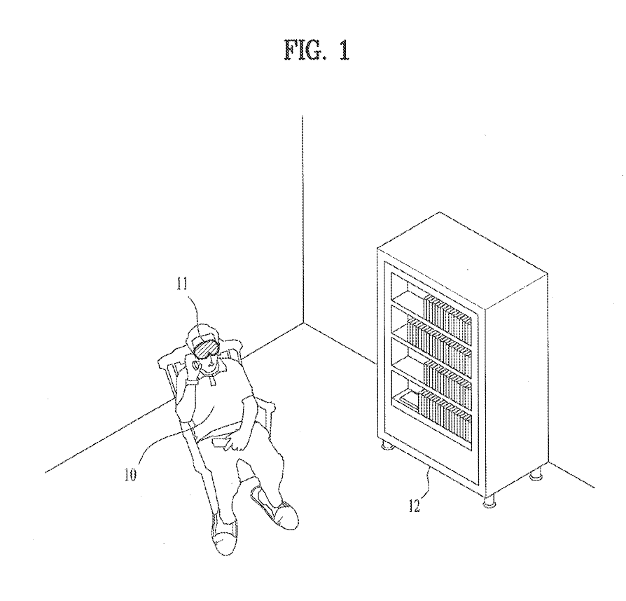

FIG. 1 is a diagram for a head mounted display (hereinafter abbreviated HMD) according to one embodiment of the present specification. A user 10 can wear the HMD 11. As depicted in FIG. I, the user 10 can use the HMD 11 indoors and may use the HMD 11 outdoors in some cases.

Before providing a virtual reality image, the HMD 11 can scan surroundings of a user. The HMD 11 can include a wide angle camera or a rotation camera capable of capturing a 360-degree image. The HMD 11 can scan surroundings using the wide angle camera or rotating the rotation camera. The HMD 11 can detect a real object 12 positioned at the outside of the HMD 11 with reference to a result of scanning for the surroundings. The HMD 11 can periodically or consecutively scan images of the surroundings. The HMD 11 can determine whether the real object 12 has a movement in a manner of comparing surrounding images, which have been respectively scanned on two timing points different from each other. In particular, the HMD 11 compares two surrounding images with each other and can determine the real object including a changed part as the real object including a movement.

The HMD 11 providing a closed-view can block a vision of a user for surroundings. Hence, if the HMD 11 does not provide separate information on the real object 12, a user wearing the HMD 11 cannot receive information on the real object 12. Hence, although a dangerous situation occurs in the vicinity of the user wearing the HMD, the user cannot receive information on the situation. In the following description, the HMD 11 providing information on the real object 12 positioned in the vicinity of the HMD is explained.

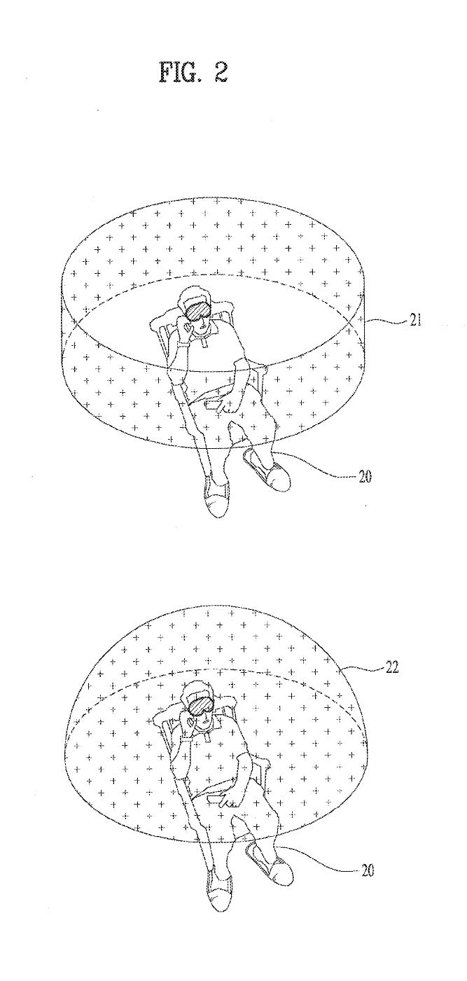

FIG. 2 is a diagram for a shape of a virtual reality image provided by a HMD according to one embodiment of the present specification. The HMD 11 can provide a virtual reality image to a user 20. As depicted in the top of FIG. 2, the HMD 11 can provide a virtual reality image 21 of a cylinder form, which surrounds a user 360-degree. The HMD 11 can provide the user with the virtual reality image 21 in every direction of the user. Hence, the user 20 turns a head of the user and can check the virtual reality image 21 displayed in a direction at which a vision of the user faces. By doing so, the HMD 11 can make the user recognize that the user belongs to a virtual reality space instead of a real space.

As depicted in the bottom of FIG. 2, the HMD 11 can provide a virtual reality image 22 of a hemisphere form, which surrounds a user 360-degree. The WAD 11 can provide the virtual reality image 22 on the top of the user as well as in every direction of the user. Hence, the user 20 turns a head of the user and can check the virtual reality image 22 corresponding to a direction at which a gaze of the user faces. By doing so, the HMD 11 can make the user recognize that the user belongs to a virtual reality space instead of a real space.

The HMD 11 provides a virtual reality image of a spherical form as well as the aforementioned cylinder form and the hemisphere form and then may provide a virtual reality image surrounding the user. A form of the virtual reality image provided by the HMD 11 according to the present specification may be non-limited to the aforementioned embodiment. The HMD 11 can provide the user with the virtual reality image of various forms.

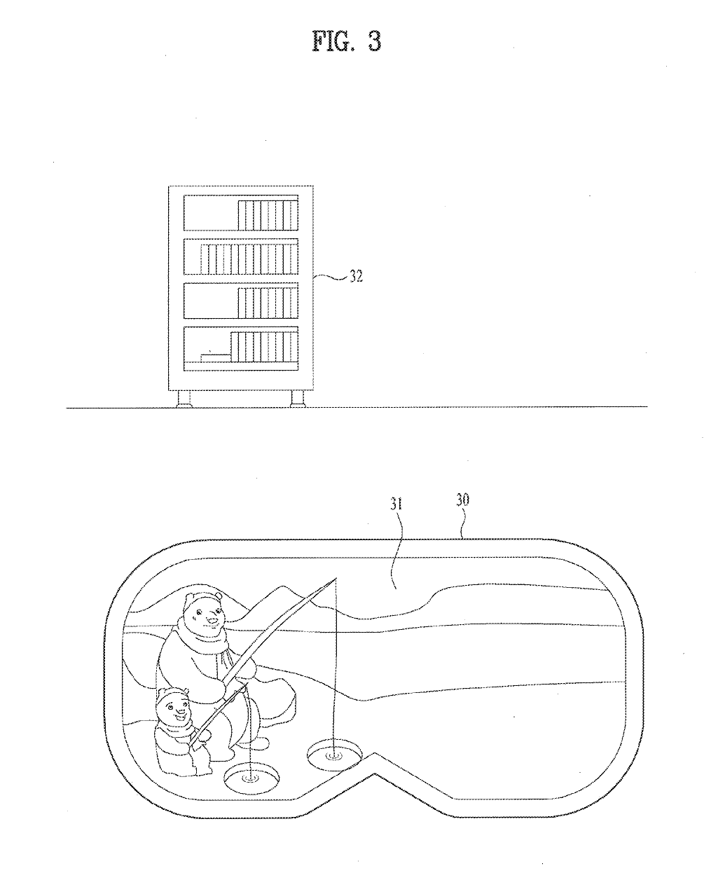

FIG. 3 is a diagram for a virtual image provided by a HMD according to one embodiment of the present specification. The HMD 11 can provide a closed-view 30 to a user. The HMD 11 can display a virtual reality image 31 in the closed-view 30, which is provided to the user via a display unit. The HMD 11 can provide the closed-view 30 to the user in a manner of displaying an opaque virtual reality image 31 in a transparent display unit. As a different embodiment, the HMD 11 may display the virtual reality image 31 in an opaque display unit.

The virtual reality image 31 provided in the closed-view 30 can block a vision of the user for a real space outside of the HMD 11. Hence, it may be difficult for the user wearing the HMD 11 to obtain information on a real object 32 positioned at the real space.

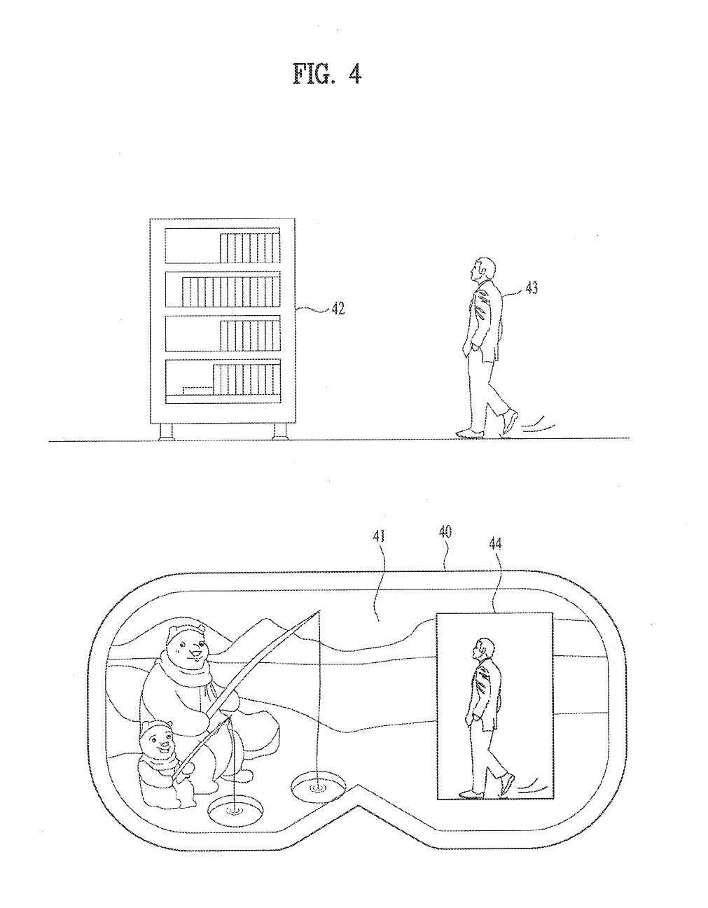

FIG. 4 is a diagram of a method for a HMD according to one embodiment of the present specification to display information on a real object in accordance with a movement of the real object. The HMD 11 detects a movement of a real object positioned at a real space and can provide information on the real object of which the movement is detected to a user.

The HMD 11 can provide a closed-view 40 to a user using a display unit. The HMD 11 displays a virtual reality image 41 in the closed-view 40 and can make the user feel that the user belongs to a virtual real space. If the virtual reality image 41 is displayed, the HMD 11 can block a vision of the user for a first real object 42 of the real space. Hence, the user wearing the HMD 11 cannot obtain information on, the first real object 42.

The HMD 11 according to one embodiment of the present specification can detect a movement of a second real object 43. The HMD 11 can provide information on the second real object 43 of which the movement is detected to a user. In particular, the HMD 11 can provide the user with information on at least one real object of which the movement is detected among real objects of the real space. By doing so, the user can also receive the information on the real object while receiving a virtual reality image via the HMD 11. The HMD 11 can provide the information on the real object to the user using a part corresponding to a position of the real object of which the movement is detected of the virtual reality image.

The HMD 11 can provide the information on the second real object 43 in a manner that a first part of the closed-view 40 is temporarily switched to an opened-view. In particular, the HMD 11 can switch the first part to an optical see-through region in response to the second real object of which the movement is detected. The optical see-through region may mean a region capable of checking a real object positioned at the real space by eyes of a user in a manner of passing through external light by increasing light penetration ratio of the region.

According to embodiment, the HMD 11 can display an image 44 of the second real object in a manner of overlapping the image with a virtual reality image 41 displayed in the closed-view 40. In particular, the HMD 11 can switch the first part to a video see-through region in response to the second real object of which the movement is detected. The video see-through region may mean a region capable of checking a real object positioned at the real space by eyes of a user in a manner of capturing a video of the real object positioned outside of the HMD and displaying the video of the real object in the closed-view in real time.

The HMD 11 can determine the first part based on a shape of an image 44, a distance from the HMD 11, a size, and a position of the second real object. A user can receive information on the second real object via the first part while wearing the HMD 11. For instance, referring to FIG. 4, the HMD 11 detects the first real object 42 in the left front of the user and can detect the second real object 43 in the right front of the user. The HMD 11 can determine the first part in response to the second real object 43 of which the movement is detected among the first and the second real object. Since the second real object is positioned at the right front of the HMD 11, the HMD 11 can determine a right region of the virtual reality image, which is currently provided to the user, as the first part. The HMD 11 can provide the information on the second real object 43 to the user in a manner of switching the first part to the optical see-through region or the video see-through region.

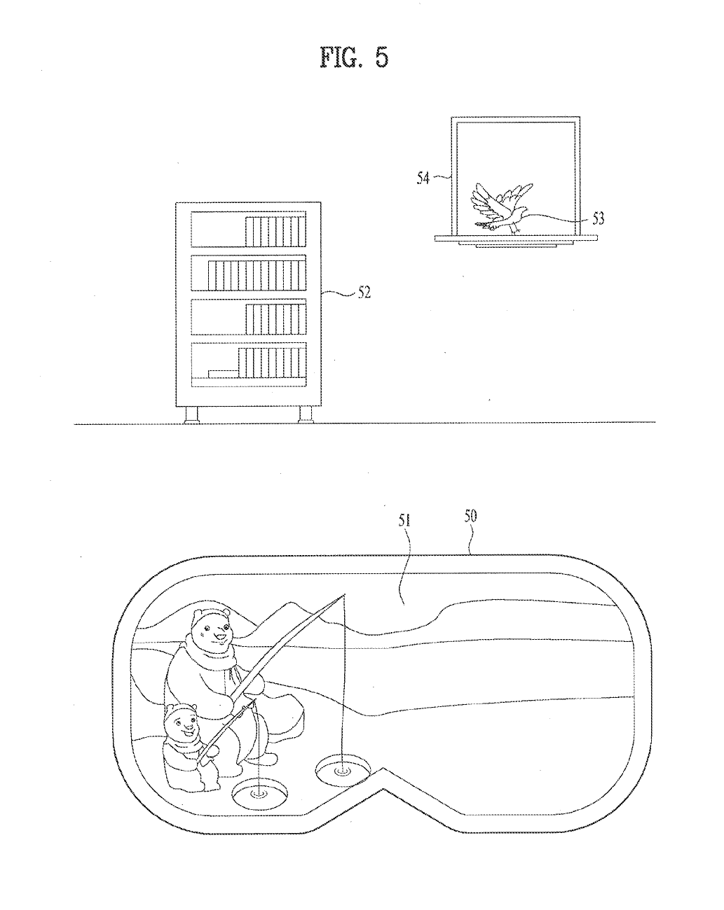

FIG. 5 is a diagram of a method for a HMD according to one embodiment of the present specification to selectively provide information on a real object of which a movement has occurred. The HMD 11 can selectively provide a user with information on a part of objects among real objects of which a movement is detected. The. HMD 11 can determine whether the information on the real object is provided based on a distance from the objects of which the movement is detected and a type of the movement.

The HMD 11 detects a movement of a real object positioned at the real space and can provide a user with information on the real object of which the movement is detected. The HMD 11 can provide the user with a closed-view 50 using a display unit. The HMD 11 displays a virtual reality image 51 in the closed-view 50 and may make the user feel that the user belongs to a virtual reality space. When the virtual reality image 51 is displayed, if a movement of a first real object 52 of the real space is not detected, the HMD 11 can block a vision of the user for the first real object 52. Hence, the user wearing the HMD 11 cannot obtain information on the first real object 52.

The HMD 11 according to one embodiment of the present specification can detect a movement of a second real object 53 and that of a third real object 54 positioned at the real space. The HMD 11 can determine whether information on the second 53 and the third real object 54 of which movements are detected is provided to a user.

The HMD 11 can determine whether the information on the real object is provided to the user based on a distance between the real object and the HMD. The HMD 11 can selectively detect a movement of the real object positioned within a first distance threshold from the HMD. In FIG. 5, the second real object 53 corresponds to a bird, which is positioned at the outside of a window, seen from a space at which the HMD 11 is positioned. Hence, the second real object 53 is positioned at the outside of the space at which the HMD 11 is positioned and may be positioned at a distance greater than the first distance threshold from the HMD 11.

In FIG. 5, if the distance between the second real object 53 and the HMD is greater than the first distance threshold, the HMD 11 can selectively ignore a second movement although the second movement of the second real object 53 is detected. Or, according to embodiment, the HMD 11 can set a distance capable of detecting a movement to the first distance threshold. Hence, the HMD 11 may not provide a user with the information on the second real object 53, which is positioned at a distance greater than the first distance threshold. In the foregoing description, the first distance threshold can be configured by a maximum distance in the space at which the HMD 11 is positioned.

In FIG. 5, the third real object 54 corresponds to a window in the space at which the HMD 11 is positioned. Hence, the third real object 54 is positioned within the space at which the HMD 11 is positioned and may be positioned at a distance less than the first distance threshold from the HMD 11. In FIG. 5, when a distance between the third real object 54 and the HMD is less than the first distance threshold, if a third movement of the third real object 54 is detected, the HMD 11 can provide the user with information on the third real object 54 positioned within the first distance threshold. The HMD 11 can configure a maximum distance in the space at which the HMD 11 is positioned as the first distance threshold. Hence, in FIG. 5, if such an event as opening the window or closing the window occurs, the HMD 11 can provide the user with information on the window corresponding to the third object 54 via the HMD 11. In particular, the HMD 11 can provide the user with the information on the third real object 54 in a manner of switching a first part of an augmented reality image 51 corresponding to the third real object 54 to an optical see-through region or a video see-through region.

And, the HMD 11 can determine whether to provide information on a real object to a user based on a type of a movement of the real object. If a movement of a fourth real object is irregular or corresponds to a one-time movement, the HHMD 11 can provide the user with information on the fourth real object. For instance, a movement of a person, a movement of an animal, a movement of a car, and the like can be defined as the irregular movement or the one-time movement.

On the contrary, if a movement of a fifth real object is regular or corresponds to a simple and repetitive movement, the HMD 11 can ignore the detection on the corresponding movement. In particular, although the movement of the fifth real object including the simple and repetitive movement is detected, the HMD 11 may not provide the user with information on the fifth real object. For instance, in case that the user wears the HMD indoors, although a pendulum of a wall clock repeatedly moves left and right, the HMD 11 may not provide information on the wall dock to the user. In case of a real object including a simple and repetitive movement, since the movement has little influence on the user, the HMD can skip the information on the real object instead of providing it to the user.

And, if the fifth real object corresponds to a display device, the HMD 11 can selectively ignore a movement of an image displayed in the display device. In particular, if the image displayed in the fifth real object corresponds to a video, the HMD may sense that the fifth real object includes a movement due to a movement of the video. Yet, since the movement of the displayed image is not the movement of the fifth real object, the HMD 11 may not provide the user with information on the fifth real object. For instance, although a screen displayed in a television, which is positioned at a space identical to a space at which the HMD is positioned, changes as time goes by, the HMD 11 can ignore the change without detecting it as a movement of the television.

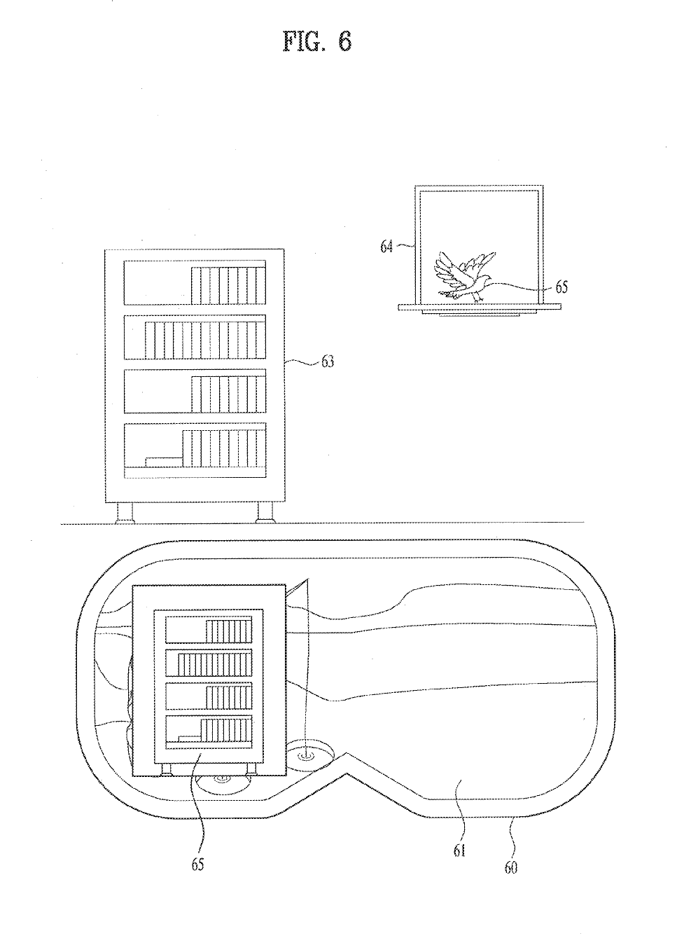

FIG. 6 is a diagram of a method for a HMD according to one embodiment of the present specification to provide information in accordance with a distance between a fixed real object and the HMD. If a distance between the fixed real object and the HMD is less than a second distance threshold, the HMD can provide information on the fixed real object to a user although the real object is fixed.

Referring to FIG. 6, the HMD 11 can provide a closed-view 60 to a user. The HMD 11 displays a virtual reality image 61 in the closed-view 60 and can make the user feel that the user belongs to a virtual space. As mentioned in the foregoing description, the HMD 11 can provide information on a real object including a movement to the user. In addition to this, although a real object does not have a movement since it is fixed, if the real object approaches within the second distance threshold, the HMD 11 can provide information on the fixed real object to the user. In FIG. 6, a first real object 63 corresponds to a fixed bookshelf positioned indoors. As mentioned earlier in FIG. 3, if a movement of the first real object 63 is not detected, the HMD 11 does not provide information on the first real object 63 to the user. The user cannot see the first real object 63 due to the virtual reality image 61 displayed in the closed-view 60.

Yet, if the first real object 63 approaches within the second distance threshold due to a movement of the user, the HMD 11 can provide information 65 on the first real object in a first part, which corresponds to the first real object 63, of the virtual reality image. The HMD 11 switches the first part of the virtual reality image to an optical see-through region and can make the user check the first real object 63 by vision via the first part. Moreover, the HMD 11 switches the first part of the virtual reality image to a video see-through region and can display an image of the first real object in a manner of overlapping the image with the first part of the virtual reality image. By doing so, despite of the closed-view of the HMD 11, the user can receive the information on the first real object, which has approached within the second distance threshold.

The HMD 11 may not provide information on the second real object 64, which is positioned at a distance greater than the second distance threshold and does not include a movement. And, as mentioned earlier in FIG. 5, if the third real object 65 is positioned at a distance greater than the first distance threshold, the HMD may not provide information on the third real object 65 to the user, although a movement of the third real object is detected.

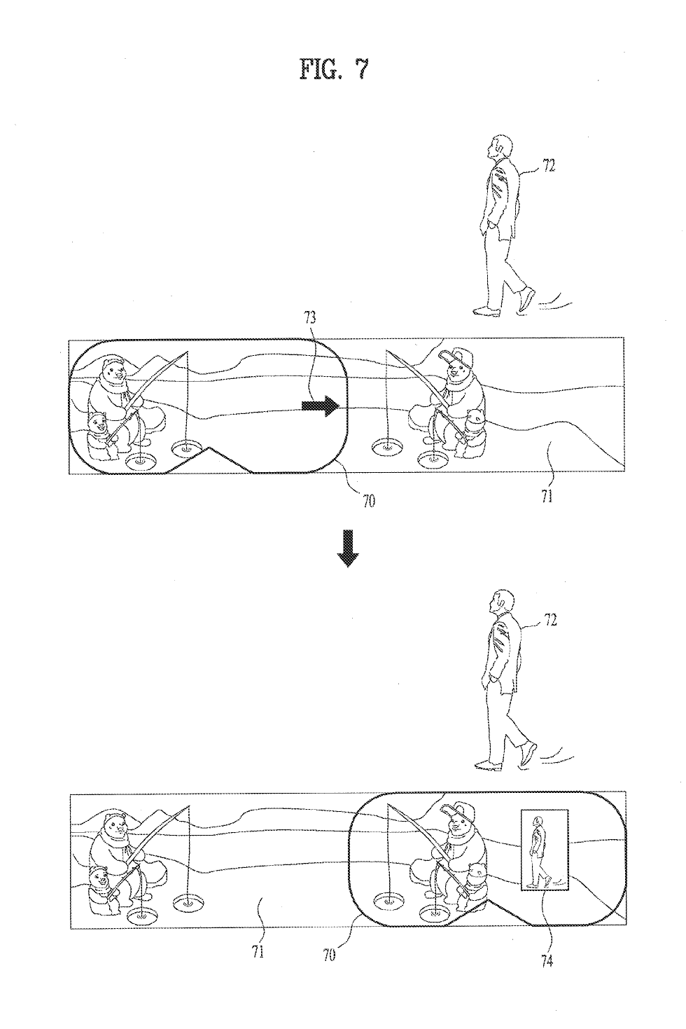

FIG. 7 is a diagram of a method for a HMD according to one embodiment of the present specification to display an indicator. The HMD 11 can display a virtual reality image in a region wider than a vision range of a user. The HMD 11 can provide the virtual reality image in every direction including the left/right and the front/rear of the user. The HMD 11 can provide the user with information on a real object via a first part, which corresponds to the real object of which a movement is detected, of the virtual reality image. If the first part corresponding to the real object occurs in a position outside of the vision range of the user, the HMD 11 can display an indicator indicating the first part in a manner of overlapping the indicator with the virtual reality image within the vision range of the user.

As depicted in the top of FIG. 7, the HMD 11 can provide a closed-view 70 to a user. The HMD 11 can display a virtual reality image 71 including a region greater than a region capable of being watched by the user via the closed-view 70. The user can check a part positioned in the closed-view 70 only by vision among the virtual reality image. The HMD 11 can detect a first real object 72 including a movement in an external real space. In this case, the HMD 11 can configure a first part, which corresponds to the first real object 72, of the virtual reality image base on a position, a shape, a size, and a distance of the first real object 72. As depicted in the top of FIG. 7, if the first real object 72 is positioned at the right of a direction at which the user is facing, the first part corresponding to the first real object 72 may not be included in the closed-view 70 of the user. In this case, the HMD 11 can display an indicator 73 of the first part in the closed-view 70 of the user. By doing so, the HMD 11 can inform the user of a direction at which the first real object of which a movement is detected is positioned in the real space. And, the user recognizes the indicator 73 of the first part and can check information on the first real object 72 by turning a gaze or a head to the right. If the user moves the gaze of the user toward the first part based on the indicator, the HMD 11 may stop displaying the indicator.

The bottom of FIG. 7 shows the HMD providing information on the first real object 72 of which a movement is detected. If the closed-view 70 of the user moves toward the first part, the HMD 11 can display the first part 74 in an augmented reality image in a manner of overlapping it with the augmented reality image. If the user checks the information on the first real object 74 provided in the first part, the HMD 11 removes the information on the first real object from the first part and can display the virtual reality image in the corresponding position. If the gaze of the user faces the information on the first real object or the information on the first real object used to enter the vision range of the user moves outside of the vision range, the HMD 11 can determine it as the user has checked the information on the first real object.

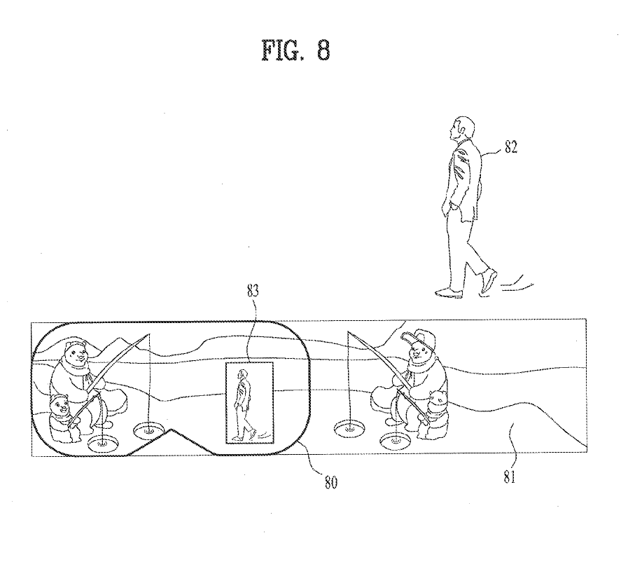

FIG. 8 is a diagram of a method for a HMD according to one embodiment of the present specification to display information of a real object using PIP (picture in picture). The HMD 11 can display a virtual reality image in a region wider than a vision range of a user. The HMD 11 can provide the virtual reality image in every direction including the left/right and the front/rear of the user. And, the HMD 11 can additionally provide the virtual reality image in at least one of the top and the bottom of the user. The HMD 11 can provide information on a real object via a first part, which corresponds to the real object of which a movement is detected, of the virtual reality image. If the first part corresponding to the real object occurs in a position outside of a vision range of the user, the HMD 11 can display a PIP for the first part in a manner of overlapping the PIP with the virtual reality image positioned within the vision range of the user.

As depicted in FIG. 8, the HMD 11 can provide the user with a closed-view 80. The HMD 11 can display a virtual reality image 81 including a region wider than a region capable of being watched by the user via the closed-view 80. The user can check a part positioned within the closed-view 80 by vision among the virtual reality image. The HMD 11 can detect a first real object 82 including a movement in an external real space. In this case, the HMD 11 can configure a first part, which corresponds to the first real object 82, of the virtual reality image based on a position, a shape, a size, and a distance of the first real object 82. As depicted in FIG. 8, if the first real object 82 is positioned at the right of a direction at which the user is facing, the first part corresponding to the first real object 82 may not be included in the closed-view 80 of the user. In this case, the HMD 11 can display the first part in the closed-view 80 as a PIP 83. In this case, the PIP 83 can be displayed in a position corresponding to a direction at which the first real object 82 is positioned among the virtual reality image provided in the closed-view 80. For instance, in FIG. 8, since the first real object 82 is positioned at the right of a vision of the user, the HMD 11 can display information on the first real object in a region where the virtual reality image 81 is displayed in the closed-view 80 as the PIP 83. By doing so, the HMD 11 can inform the user of the direction at Which the first real object of which a movement is detected is positioned in the real space. And, the user recognizes the PIP 83 and may receive information on the first real object 82 via the first part by turning a gaze or a head to the right. If the user checks the PIP 83 or checks the information on the first real object via the first part, the HMD 11 may stop displaying the PIP 83.

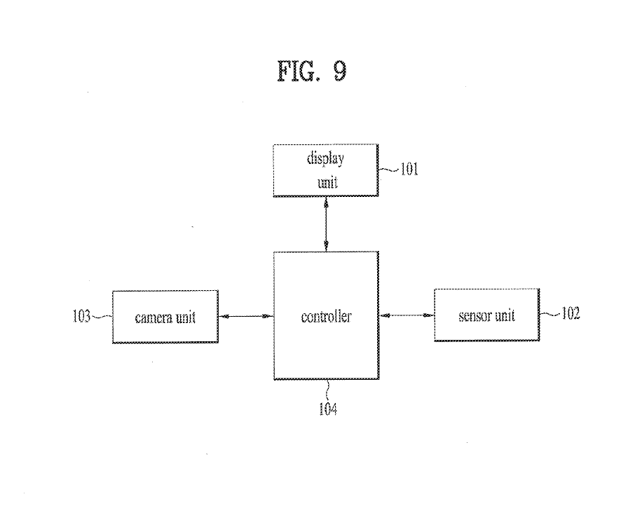

FIG. 9 is a block diagram for a HMD according to one embodiment of the present specification. The HMD can include a display unit 101, a sensor unit 103, a camera unit 103, and a controller 104.

The display unit 101 can display a virtual reality image. The HMD can track a head movement of a user and the display unit 101 can change a region in which the virtual reality image is displayed according to the head movement of the user. By doing so, wherever the user faces among the front side, the flank, or the rear side, the user can see the virtual reality image allocated to each side. Hence, the user may feel as if the user belongs to a virtual space made by the virtual reality image.

The display unit 101 can provide a closed-view to the user. The closed-view means to see the virtual reality image only provided by the HMD while the user is wearing the HMD. In particular, the display unit 101 can block information on a real object belonging to a real space outside of the HMD in a manner of providing an opaque virtual reality image to the user. By doing so, the display unit 101 can provide the user with the virtual image of sensation of high immersion.

The display unit 101 can switch a part of the closed-view to an opened-view according to a control of the controller 104. As mentioned earlier in FIG. 4, if a movement of a real object is detected, the controller can configure a first part on the virtual reality image based on at least one selected from the group consisting of a position, a size, a shape, and a distance of the real object. The display unit 101 can switch the first part, Which is configured in response to the real object, to a region including the opened-view. The display unit 101 can switch the first part to an optical see-through region or a video see-through region. In particular, a user can check information on the real object by vision via a view for the real space secured by the first part corresponding to the optical see-through region. And, the user can cheek the information on the real object displayed in the first part corresponding to the video see-through region by vision.

According to embodiment, the display unit 101 can include at least one selected from the group consisting of LED (light-emitting diode), OLED (organic light-emitting diode), LCD (liquid crystal display), and a beam projector.

The sensor unit 102 can include an input sensor configured to sense a control input inputted to the HMD, a movement sensor configured to sense a movement of the HMD and that of a real object, an orientation sensor configured to sense an orientation of the HMD, a distance sensor configured to sense a distance between the HMD and the real object.

The input sensor can sense a control input inputted to the HMD. As mentioned in the foregoing description, if a movement of a real object is detected, the HMD can set a first part corresponding to the real object to a see-through region. According to embodiment, if the movement of the real object is detected, the HMD firstly displays an indicator for the real object. And then, if a control input is sensed by the input sensor, the HMD may switch the first part to the see-through region.

The movement sensor can sense a first movement of the real object. The movement sensor can deliver information on the real object of which the first movement is sensed to the controller. Although the first movement is sensed in a part of the real object, the movement sensor can deliver information on the whole shape of the real object to the controller.

The movement sensor can sense a second movement of the HMD. In detecting the first movement of the real object, the HMD can revise an impact due to the second movement of the HMD itself. Hence, the movement sensor can additionally sense the second movement of the sensor unit configured to sense the HMD itself or the real object. The movement sensor can compensate for the first movement using the sensed second movement. By doing so, the movement sensor can precisely sense the first movement of the real object.

The orientation sensor can sense an orientation of the HMD. The orientation sensor delivers the orientation of the sensed HMD to the controller and the controller can determine which region among a virtual reality image is displayed in the display unit based on the orientation.

The distance sensor can measure a distance to the real object sensed by the movement sensor or the camera unit. As mentioned earlier in FIG. 5 to FIG. 6, the HMD can determine whether to provide information on the real object to a user according to a measurement result of the distance sensor. In particular, if a distance to a first real object measured by the distance sensor is greater than a first distance threshold, the HMD may not provide information on the first real object to the user although a movement of the first real object is detected. In other word, the HMD can selectively provide the user with information on the real object of which a movement is detected among the real objects positioned within the first distance threshold.

And, if a distance to a second real object measured by the distance sensor is less than a second distance threshold, the HMD can provide information on a second real object to the user although a movement of the second real object is not detected. In particular, the HMD does not provide the user with information on the real object of which a movement is not detected. Yet, exceptionally, if the real object is positioned within the second distance threshold, the HMD can provide the user with the information on the real object although a movement is not detected.

The sensor unit 102 can deliver sensed information to the controller 104.

The camera unit 103 scans a space at which a real object and the HMD are positioned and can capture it as a digital image. Similar to the sensor unit, the camera unit 103 can detect a movement of the real object. And, the camera unit 103 scans a space at which the HMD is positioned and can store information on real objects positioned at the space. The camera unit 103 can deliver information on the scanned space to the controller. In providing the information on the real object, the controller can exclude information on the real object, which is previously existed in the scanned space. Hence, the HMD can selectively provide the user with information on the real object, which has newly entered the space at winch the HMD is positioned.

The controller 104 can control the display unit 101 using the information delivered from the camera unit 103 and the sensor unit 102. The controller 104 can receive information on a real object outside of the HMD from the sensor unit and the camera unit. The controller 104 can determine whether to provide the information on the real object to the user based on a distance between the real object and the HMD, information on whether a movement of the real object occurs, and a type of the movement.

If it is determined that the information on the real object is going to be provided to the user, the controller 104 can configure a see-through region in a first part of a virtual reality image in a manner of controlling the display unit. According to embodiment, the controller 104 can configure an optical see-through region or a video see-through region in the first part of the virtual reality image. The controller 104 can provide the user with the information on the real object via the see-through region. The information on the real object can include a shape, a size, and a movement of the real object.

FIG. 9 is a block diagram according to one embodiment of the present specification. Blocks represented as being separated are depicted for elements of the HMD in a manner of being logically distinguished. Thus, the aforementioned elements of the HMD may be equipped with a single chip or a plurality of chips according to a design of the HMD.

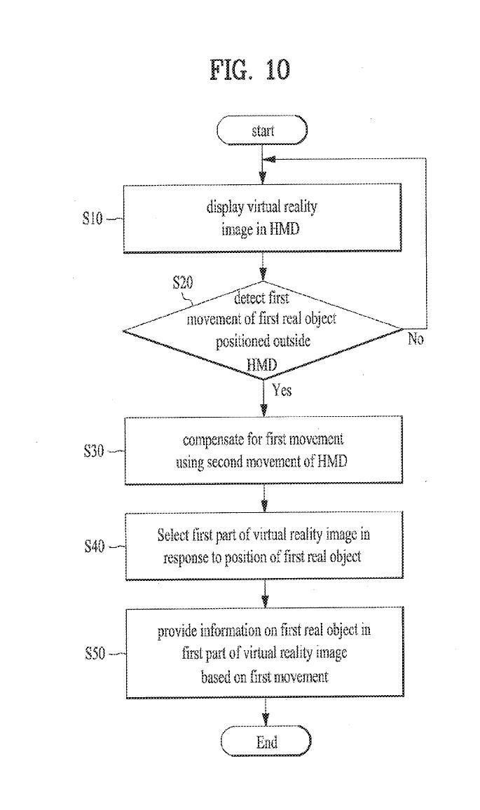

FIG. 10 is an operation flowchart for a HMD according to one embodiment of the present specification. The HMD can display a virtual reality image in a display unit [S10]. The HMD can provide a virtual reality image to a user. As mentioned earlier in FIG. 2, the HMD can display a virtual reality image of a cylinder form surrounding the user 360-degree. The HMD can provide the user with a virtual reality image in every direction of the user. Hence, the user can check the virtual reality image displayed in the front direction and the virtual reality image displayed in other regions in a manner of turning a head to every direction. By doing so, the HMD can make the user recognize that the user belongs to a virtual reality space instead of a real space.

And, the HMD can provide a user with a virtual reality image of a hemisphere form surrounding the user. The HMD can provide the virtual reality image on the top of the user as well as in every direction of the user. Hence, the user turns a head of the user and can check the virtual reality image corresponding to a direction at which a gaze of the user faces. By doing so, the HMD can make the user recognize that the user belongs to a virtual reality space instead of a real space.

The HMD can detect a first movement of a first real object positioned at the outside of the HMD [S20]. The HMD can detect the first movement of the first real object using a camera unit or a sensor unit. According to embodiment, if a simple and repetitive movement is detected, the HMD can ignore the movement. In particular, the HMD can exclude information on a real object including the simple and repetitive movement from an object for providing information. The HMD can include information on a real object only including one-time movement, an irregular movement, and a newly detected movement in the object for providing information. And, as mentioned earlier in FIG. 5, the HMD can selectively detect the first movement of the first real object positioned within a first distance threshold. If a movement of a real object positioned at a distance greater than the first distance threshold is detected, the HMD may not provide information on the real object.

The HMD can compensate for the first movement using the HMD itself or a. second movement of a sensor unit [S30]. The first movement mentioned earlier in the step S20 may include a component of the second movement occurred by a movement of the HMD itself or that of the sensor unit. For instance, if a user wearing the HMD moves to the front, the HMD can detect it as a fixed real object positioned in the front moves toward the HMD. Yet, this is not a movement of the fixed real object but a movement occurred due to a movement of the HMD itself. In this case, the HMD can compensate for the first movement using the second movement. The HMD excludes a component of the second movement from the first movement and can extract a unique movement component of the first real object from the first movement. Hence, the HMD can obtain the first movement of the first real object not including the movement component of the HMD itself or that of the sensor unit.

The HMD can configure a first part of a virtual reality image in response to a position of the first real object [S40]. The HMD can configure the first part based on a shape of the first real object, a distance between the HMD and the first real object, a size of the first real object, and a position of the first real object. For instance, the HMD can detect the first real object in the right front of a user. The HMD can determine the first part in response to the first real object of which a movement is detected. Since the first real object is positioned at a region in the right front of the HMD, the HMD can determine the right side region of the virtual reality image provided to the user as the first part. And, the HMD can determine a size and a shape of the first part based on a distance between the HMD and the first real object, a size, and a shape of the first real object.

The HMD can selectively provide information on the first real object in the first part of the virtual reality image based on the first movement [S50]. The HMD can temporarily switch the configured first part to an optical see-through region or a video see-through region and can provide information on the first real object to a user. By doing so, if there exists a real object of which a movement occurs in the outside, the user can receive the information on the real object while receiving the virtual reality image of high immersion using the HMD including a closed-view.

As mentioned in the foregoing description, the HMD according to the present specification can provide the user with the information on the real object positioned at the outside of the HMD in a manner of selectively switching a part of the closed-view to an opened-view while providing the closed-view. By doing so, the user can recognize and prepare for a risk element and the like in a situation that a vision for an external environment is blocked by the HMD.

It will be apparent to those skilled in the art that various modifications and variations can be made in the present specification without departing from the spirit or scope of the inventions. Thus, it is intended that the present specification covers the modifications and variations of this invention provided they come within the scope of the appended claims and their equivalents.

What is claimed is:

1. A head mounted display (HMD) providing a closed-view, comprising:
a display unit configured to display a virtual reality image;
a sensor unit configured to sense a real object positioned outside the HMD; and
a controller configured to control the display unit and the sensor unit,
wherein the controller is further configured to:
detect a first movement of a first real object via the sensor unit,
provide information on the first real object in a first part of the virtual reality image based on the first movement, wherein the first part is selected in response to a position of the first real object,
compensate for a second movement of the sensor unit, which has sensed the first real object, in case of detecting the first movement of the first real object.

2. The HMD of claim 1, wherein the controller is further configured to:
switch the first part of the display unit to a see-through region and provide the information on the first real object via the first part.

3. The HMD of claim 1, further comprising a camera unit configured to obtain an image of the first real object, wherein the controller is further configured to display the image of the first real object in the first part of the display unit.

4. The HMD of claim 1, wherein the sensor unit is further configured to scan surroundings of the HMD before sensing the first movement of the first real object positioned outside of the HMD.

5. The HMD of claim 4, further comprising a camera unit configured to obtain an image of the surroundings, wherein the controller is further configured to scan the surroundings of the HMD by rotating the camera.

6. The HMD of claim 4, wherein the controller is further configured to periodically or consecutively scan images of the surroundings and sense the first movement of the first real object in a manner of comparing the images of the surroundings, which have been scanned on two timing points, respectively.

7. The HMD of claim 1, wherein the first part is determined based on at least one of a shape, a size, or a distance of the first real object.

8. The HMD of claim 1, wherein the controller is further configured to selectively detect the first movement of the first real object positioned at a distance within a first distance threshold from the HMD.

9. The HMD of claim 8, wherein the controller is further configured to selectively ignore the first movement of the first real object positioned at a distance greater than the first distance threshold from the HMD.

10. The HMD of claim 1, wherein when the first movement of the first real object is repetitive, the controller is further configured to selectively ignore the first movement of the first real object.

11. The HMD of claim 1, wherein the controller is further configured to:
detect a second real object of a fixed position via the sensor unit, and
when the second real object approaches within a second distance threshold, provide information on the second real object in a second part of the display unit, wherein the second part is selected in response to a position of the second real object.

12. The HMD of claim 1, wherein when the first real object corresponds to a display device, the controller is further configured to selectively ignore the first movement of an image displayed in the display device.

13. The HMD of claim 1, wherein the controller is further configured to remove a component generated by the second movement from a component of the first movement in case of compensating for the second movement of the sensor unit.

14. The HMD of claim 1, wherein when the virtual reality image is provided for a range wider than a vision of a user and the first part occurs in a position outside the vision range of the user in the virtual reality image, the controller is further configured to display the information on the first real object in the virtual reality image positioned within the vision range of the user in a picture-in-picture (PIP).

15. The HMD of claim 1, wherein the virtual reality image is provided in every direction of a user and wherein when the first part occurs in a position outside a vision range of the user in the virtual reality image, the controller is further configured to display an indicator of the first part within the vision range of the user.

16. The HMD of claim 15, wherein when the user moves a gaze to the first part based on the indicator, the controller is further configured to stop displaying the indicator.

17. The HMD of claim 1, wherein when the information on the first real object provided in the first part is checked by the user, the controller is further configured to remove the information on the first real object from the first part and display the virtual reality image in the first part.

18. The HMD of claim 17, wherein when a gaze of a user faces the provided information on the first real object or when the provided information on the first real object moves outside a vision range of the user; the controller is further configured to detect that the user has checked the information on the first real object.

19. The HMD of claim 1, wherein when the first movement occurs in a part of the first real object only, the controller is further configured to provide a whole shape of the first real object in the first part.

20. A method of controlling a head mounted display (HMD) providing a closed-view, comprising the steps of:
displaying a virtual reality image;
detecting a first movement of a first real object positioned outside the HMD; and
providing information on the first real object in a first part of the virtual reality image based on the first movement,
wherein the first part is selected in response to a position of the first real object and wherein the first movement is compensated by a second movement of the HMD in case of performing the step of detecting the first movement of the first real object.
